(19) United States
(12) Patent Application Publication
(10) Pub. No.: US 2008/0196319 A1
(43) Pub. Date: Aug. 21, 2008

(54) CERAMIC ROUND TOOLS FOR THE MACHINING OF COMPOSITE MATERIALS

(75) Inventors: Joseph P. Halloran, Tucson, AZ (US); Zachary N. Wing, Tucson, AZ (US); Mathias Hecht, Tucson, AZ (US)

Correspondence Address: BANNER & WITCOFF, LTD., TEN SOUTH WACKER DRIVE, SUITE 3000, CHICAGO, IL, 60606, US

(73) Assignee: Advanced Ceramic Manufacturing, LLC, Tucson, AZ (US)

(21) Appl. No.: 11/676,948

(22) Filed: Feb. 20, 2007

(51) Int. Cl. C09K 3/14

(52) U.S. Cl. 51/309

(57) ABSTRACT

A tool, such as a monolithic ceramic round tool or ceramic inserted round tool fabricated from materials containing silicon nitride, is used for machining composite materials, plastics, and graphite. The tool contains at least a β-silicon nitride phase and a grain boundary phase that is composed of rare earth element oxides such as zirconia, yttria, ceria, and compounds that contain elements such as aluminum, magnesium, silicon, nitrogen and oxygen. The tool is formed by consolidating powder components at elevated temperature. The consolidated ceramic has a porosity of less than 2 vol. %. Composite materials that can be machined include glass fiber-polymer composites, whisker reinforced polymer composites, and carbon fiber containing composites.

### TECHNICAL FIELD

The invention relates to ceramic tools for machining plastics, graphite, and composite materials including, but not limited to, glass fiber-polymer composites, carbon fiber-polymer composites, carbon-carbon composites, and whisker reinforced polymer composites. In some particular embodiments, the present invention relates to the use of round tools or inserts for round tools containing silicon nitride for cutting these materials.

### BACKGROUND

Composite materials and high-performance plastics are becoming increasingly pervasive for use in high strength/low weight applications. Industries of use include (but are not limited to): naval, automotive, sporting goods, and aerospace. The state of composite and plastic technology is maturing rapidly to the point where structural components of commercial airliners are anticipated to consist mostly of carbon fiber composites. The very nature of composites, which contain strong and abrasive fibers within a polymer matrix, presents unique problems in machining operations. Machining operations are typically achieved via the abrasive removal of material from a work piece by a tool, and the material removed may take the form of chips or fine particulates.

Cutting fluids have not found widespread use in composite manufacturing, because they can chemically degrade the polymer matrix of the composites. In addition, the applied cutting fluid can penetrate layered composite structures and cause delamination. A possible solution to this issue has been disclosed by Sutcliffe (U.S. Pat. No. 4,519,732) that uses the binder of the polymer in an uncured state. However, this application results in health and flammability hazards and a poor finish quality. Accordingly, dry machining is most common.

Conventional cutting tools can cut the polymer matrix, but the reinforcing fibers are hard and abrasive. This leads to a rapid increase in tool temperature and high tool wear rates. The high tool temperature can degrade the polymer matrix and localized melting leads to inadequate surface finishes. This tool wear can also cause fiber pull-out and weaken the composite. Tungsten carbide is used in some cutting applications, but expensive diamond tooling is often required to achieve the desired combination of cutting performance and tool life.

Conventional cutting tools can cut plastics. However, slow material removal rates are necessary to prevent heat build up and the melting or thermal destruction of the material to be machined.

Material removal must occur rapidly for machining operations to be productive. High removal rates require greater feed rates and therefore cause higher forces. Metal-based tools are used due to their high toughness and strengths not achievable in other materials. However, they exhibit a high wear rate which requires frequent tool changes. Ceramic materials are typically significantly harder and have lower thermal conductivities. However, their inherent brittleness can cause prior art ceramic tools to fail catastrophically.

Round tools used to machine composite materials are currently fabricated from metal carbides and metal carbides with polycrystalline diamond brazed tips. Carbide round tools wear rapidly while machining composites. Polycrystalline diamond brazed tools are prohibitively expensive for the majority of applications. In addition, coated carbides show improved lifetimes, but further gains in productivity are necessary.

Conventionally, silicon nitride containing ceramic cutting tools have been used to machine and finish cast iron. The fabrication of silicon nitride materials for these applications and suitable ceramic material compositions have been disclosed in U.S. Pat. Nos. 4,264,548; 4,304,576; 4,401,617; and 4,434,238. A detailed structural description of a silicon nitride microstructure has been disclosed by Moriguchi et al. in U.S. Pat. No. 5,171,723. The addition of hard ceramic whiskers in silicon nitride materials has been a common route to increase the fracture toughness of the materials as described by Baldoni et al. in U.S. Pat. No. 5,250,477. Alternatively, niobium and/or tantalum carbide or nitride second phase additions have been found to reinforce silicon nitride ceramics, such as disclosed in U.S. Pat. Nos. 6,066,582 and 6,187,254.

Silicon nitride compositions for the cutting of metals have also been described in U.S. Pat. Nos. 5,382,273 and 5,525,134. Titanium nitride has been added to silicon nitride ceramics to improve abrasion resistance, as disclosed in U.S. Pat. No. 5,432,132. The inherent brittleness of all ceramic materials has also been attempted to be overcome by particular tool designs disclosed in U.S. Pat. Nos. 5,641,251 and 6,314,798. A decrease in surface coarsening to increase durability for cutting of cast iron has been described in U.S. Pat. No. 5,668,069.

More recently, coatings have been applied to these ceramic cutting tools, such as disclosed in U.S. Pat. No. 6,447,896, to reduce tool wear. Other approaches to improve the silicon nitride tools have been described. For example, U.S. Pat. Nos. 6,861,382 and 6,863,963 disclose a sintered silicon nitride tool that has a supported cutting edge for these applications that is not prone to chipping.

The present assembly is provided to solve the problems discussed above and other problems, and to provide advantages and aspects not provided by prior cutting tools of this type. A full discussion of the features and advantages of the present invention is deferred to the following detailed description, which proceeds with reference to the accompanying drawings.

### SUMMARY OF THE INVENTION

According to one aspect, a ceramic material includes at least 10 weight % silicon nitride, between 0 and 3 weight % multi-walled carbon nanotubes, between 0 and 80 weight % of titanium nitride, and between 2 and 20 weight % of an intergranular phase that includes at least two oxides of elements selected from the group consisting of: magnesium, aluminum, and rare earth metals (e.g., zirconium, yttrium, lanthanum, cerium, praseodymium, neodymium, promethium, samarium, europium, Gadolinium, terbium, dysprosium, holmium, erbium, thulium, ytterbium, and lutetium).

According to another aspect, a method for manufacturing a tool part includes several steps. A powder mixture is provided that includes at least 10 weight % silicon nitride, between 0 and 3 weight % multi-walled carbon nanotubes, between 0 and 80 weight % titanium nitride, and between 2 and 20 weight % of an oxide mixture including at least two oxides of elements selected from the group consisting of: magnesium, aluminum, and rare earth metals. The powder is formed into a pre-form, and the pre-form is consolidated into a blank by heating to a temperature in the range of from 1650° C. to 1850° C. The blank is machined to form the tool part.

According to another aspect, a method for machining a piece includes several steps. The piece is provided, along with a ceramic cutting tool made from a material containing silicon nitride. The piece is machined using the cutting tool. In various embodiments, the piece is can be made from a composite material such as a graphite fiber reinforced polymer, a glass fiber reinforced polymer, a polymer with 0-90 weight % of carbon or graphite fibers, a whisker reinforced polymer, or a laminate structure comprising graphite fiber reinforced polymer layers and metallic layers.

Other features and advantages of the disclosure will be apparent from the following specification taken in conjunction with the following drawings.

### BRIEF DESCRIPTION OF THE DRAWINGS

To understand the various aspects of the present invention, they will now be described by way of example, with reference to the accompanying drawings in which:

FIG. 1 is a scanning electron microscopy image of the microstructure of an etched sample of one embodiment of the material used for a cutting tool;

FIG. 2 is a graph of tool wear-related hole size changes of a standard carbide round tool and a tool incorporating a material of the present disclosure for the cutting of carbon fiber polymer composites at a surface speed of 458 ft/min;

FIG. 3 is a graph of tool wear-related hole size changes of a standard carbide round tool and a tool incorporating a material of the present disclosure for the cutting of carbon fiber polymer composites at a surface speed of 65 ft/min;

FIG. 4 is a plan view of several embodiments of blanks and tool inserts; and

FIG. 5 is a plan view of several embodiments of round tools.

### DETAILED DESCRIPTION

While this disclosure is susceptible of embodiments in many different forms, there are shown in the drawings and will herein be described in detail certain exemplary embodiments of with the understanding that the present disclosure is to be considered as an exemplification of the principles of the invention and is not intended to limit the broad aspect of the invention to the embodiments illustrated.

An improved approach for machining of composites utilizes a round tool or inserts for a round tool fabricated from silicon nitride-containing ceramic materials. The present disclosure includes materials that create improved tool performance, tools made from materials disclosed herein, methods for manufacturing such tools and materials, and methods for machining composite materials using such tools.

A method is disclosed for manufacturing materials and tools from ceramic powder mixtures. In one exemplary embodiment, the ceramic powder mixture contains 80-95 weight % silicon nitride. In another exemplary embodiment, the ceramic powder mixture contains a mixture of silicon nitride and up to 3 weight % multi-walled carbon nanotubes. In another exemplary embodiment, the ceramic powder mixture contains a mixture of silicon nitride and titanium nitride with up to 70 weight % of titanium nitride and at least 10 weight % silicon nitride, with the addition of 2-20 weight % of one or more ceramic materials which forms an intergranular phase to the silicon nitride. In another exemplary embodiment, the mixture contains 4-20 weight % of the intergranular phase. In another exemplary embodiment, the mixture contains 7-13 weight % of the intergranular phase. In another exemplary embodiment, the mixture may contain up to 80 weight % titanium nitride. Certain embodiments have an average particle size of the silicon nitride powder of between 0.2 and 2 μm. In some embodiments, the intergranular phase may contain oxides of rare earth elements, such as yttrium, zirconium, cerium, lanthanum, praseodymium, neodymium promethium, samarium, europium, Gadolinium, terbium, dysprosium, holmium, erbium, thulium, ytterbium, and lutetium, as well as oxides of other elements, such as aluminum and magnesium. Accordingly, in various exemplary embodiments, the powdered mixture contains at least one oxide selected from the groups listed above. In other exemplary embodiments, the powdered mixture contains several oxides selected from those groups. In one exemplary embodiment, the intergranular phase contains at least one of alumina (aluminum oxide) and magnesia (magnesium oxide), along with at least one of ceria (cerium oxide), zirconia (zirconium oxide), and yttria (yttrium oxide).

One exemplary embodiment of the ceramic powder mixture contains between 2 and 8 weight % of aluminum or magnesium oxide, between 2 and 8 weight % of yttrium or cerium oxide, and between 0 and 5 weight % of zirconium oxide. In certain exemplary embodiments, the average particle size of the powders for the intergranular phase is 0.01 to 1 μm. In one embodiment, the average particle size of the intergranular phase powder is less than 50 nm. It is understood that, in other embodiments, the ceramic powder mixture may contain different compositions and mixtures of the oxides described above. It is further understood that, in various embodiments, the mixture may contain intergranular materials other than those described above, or other additional materials.

One suitable silicon nitride powder for use as disclosed herein is grade SN-E10 from Ube Industries, Ltd., of Tokyo, Japan, or as grade M11 from Herman C. Stark of Germany. Suitable multi-walled carbon nanotubes for use as disclosed herein are available from Sigma Aldrich. One suitable titanium nitride powder for use as disclosed herein is grade C from Herman C. Stark of Germany. One suitable magnesia powder for use as disclosed herein is available from the Chemical Division of Fisher Scientific, Inc. of Fair Lawn, N.J. One suitable alumina powder for use as disclosed herein is available from Herman C. Stark of Germany. Examples of suitable ceria, zirconia, and yttria powders for use as disclosed herein are available from Reade Advanced Materials, Sparks, Nev. or from Nanostructured & Amorphous Materials, Inc.

An exemplary embodiment of a method for manufacturing a cutting tool as disclosed herein is described as follows. The materials in the powder mixture are measured by weight and placed in a plastic vessel with silicon nitride or zirconia balls and a solvent, such as ethanol or hexane, and mixed for 4 to 48 hours. The resultant slurry is dried into a powder cake. The resultant cake is then mechanically broken up and sieved through a 325 mesh sieve to obtain a powder. In an alternate embodiment, the slurry can be spray dried to form the powder.

In one embodiment, the obtained powder is then transformed into green-state cylindrical blanks or insert pre-forms by green forming methods known to those skilled in the art. Examples of green forming techniques can include slip casting, extrusion, powder pressing, or gel casting with binders such as polymers, wax, or other substances. The ceramic material is consolidated from the blanks by firing of the green-state blanks or insert pre-forms at temperatures between 1650 and 1850° C. in one embodiment and between 1710 and 1770° C. in another embodiment. In these embodiments, the firing is done in a nitrogen or argon atmosphere, with or without applied external pressure to the samples. In an alternate embodiment, the ceramic material is consolidated from powder by hot pressing at a pressure of between 3000 and 5000 psi, at a temperature between 1710 and 1750° C.

It is understood that the above method may contain alternate or additional procedures known to those in the art for ceramic processing, and it is contemplated that in some embodiments, the method will contain such alternate or additional procedures.

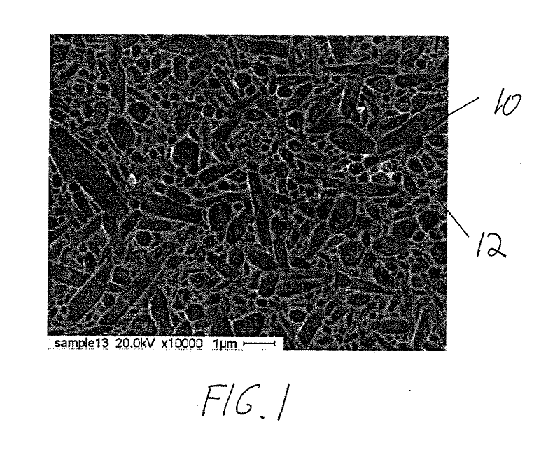

An exemplary microstructure of the ceramic material obtained from the above-described procedure is illustrated in FIG. 1. The microstructure exhibits predominately elongated, acicular β-silicon nitride grains 10 surrounded by an intergranular phase 12 containing sintering aids and compounds formed by the interaction of the sintering aids with silica present on the skin of the silicon nitride particles.

The composition of the resultant ceramic material is substantially the same as the composition of the various ceramics in the powder used to manufacture it. Accordingly, in various embodiments, the ceramic material may have a composition substantially identical to any of the exemplary powder mixtures described above with respect to the manufacturing process. In one exemplary embodiment, the ceramic material ceramic contains at least 80 weight % silicon nitride, and 20 or less weight % of an intergranular phase. In other embodiments, the material contains silicon nitride with 7-13 weight % of an intergranular phase containing one or more oxides of aluminum, magnesium, yttrium, zirconium, and/or cerium. In further embodiments, up to 70 weight % of the silicon nitride content described in the embodiments above can be replaced by titanium nitride. Accordingly, such an embodiment may contain at least 10 weight % silicon nitride and up to 70 weight % titanium nitride. In another exemplary embodiment, up to 80% of the silicon nitride content may be replaced by titanium nitride. It is understood that some materials in the powder mixture may no longer be present in the resultant ceramic material, and that the ceramic material may contain additional materials not added to the ceramic powder. For example, the silicon and titanium nitrides may form oxides or other compounds of silicon or titanium in the ceramic.

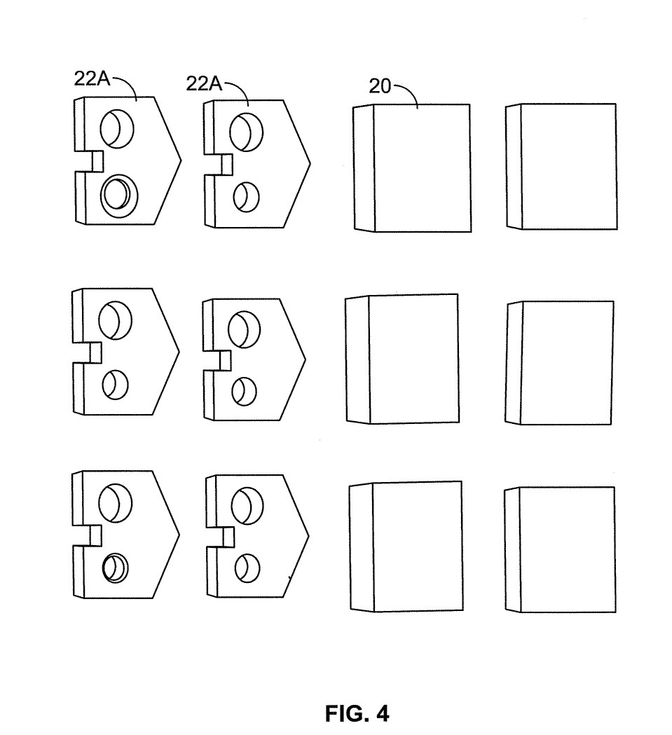

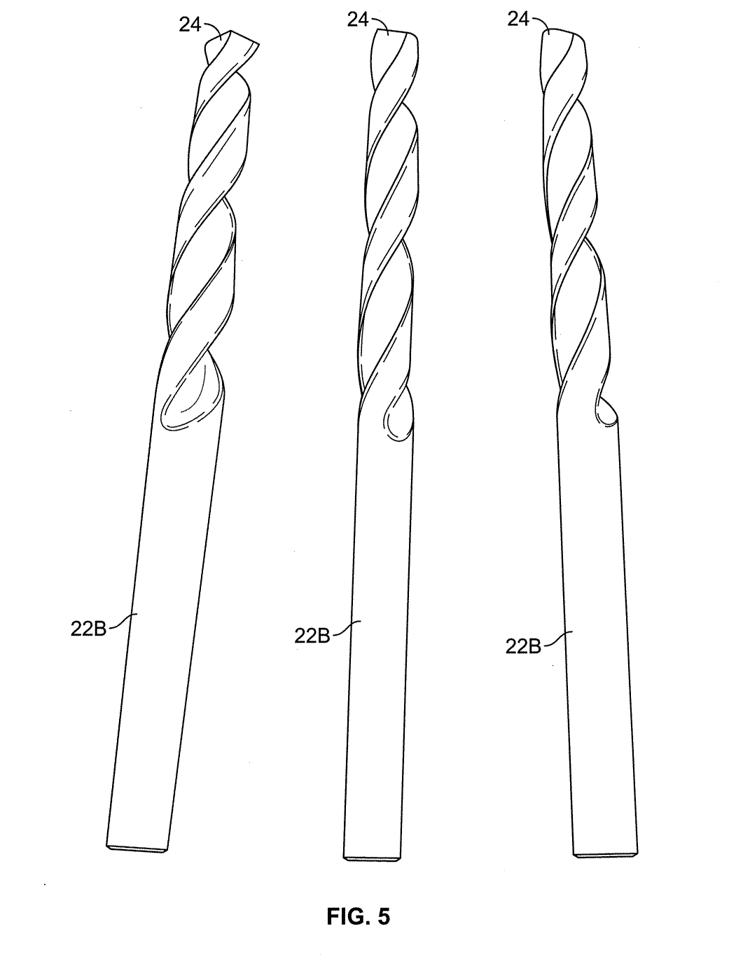

The ceramic material can be machined into blanks 20, such as cylinders or insert pre-forms near net shape, examples of which are shown in FIG. 4. Machining can be performed, in one embodiment, by grinding to the desired dimensions and shape using methods known to persons skilled in the art. In one exemplary embodiment, the resultant ceramic cylinders or insert pre-forms have at least 98 vol. % of the full theoretical density, i.e., have a porosity of less than 2 volume %. Then, the fluting for round tools or the final shape can be cut into the ground blanks 20, such as by using commercially available CNC machines, to produce tool parts 22, for example tool inserts 22A such as the examples illustrated in FIG. 4, or round tools 22B such as the examples illustrated in FIG. 5. The round tools 22B shown in FIG. 5 have a fluted portion 24 adapted for cutting. The tool part 22 may be, for example, a monolithic ceramic body, or may contain a tool insert. Examples of suitable CNC machines for the disclosed process are those produced by Excalibur Tool, Inc. of Murphy, Oreg.

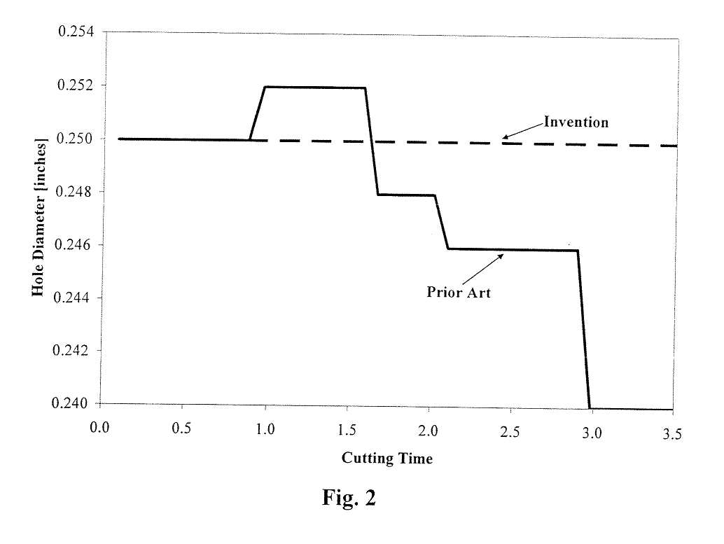

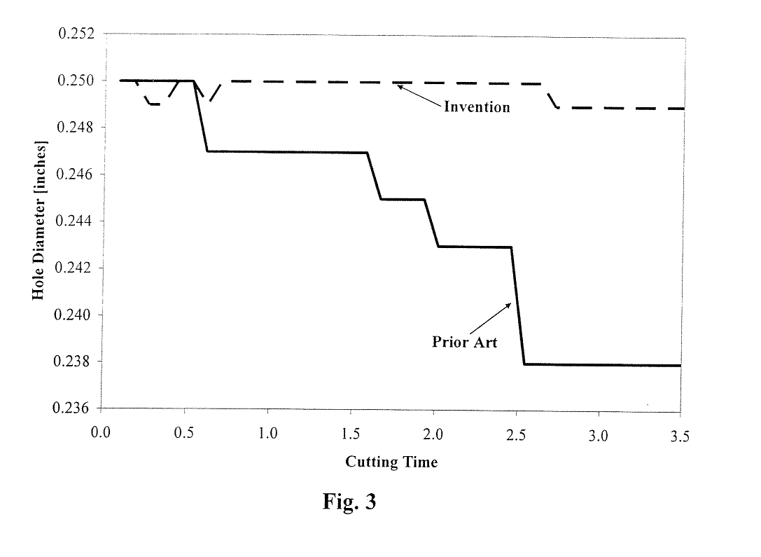

It has been discovered that the silicon nitride round tool markedly increases tool life and hole quality in machined composites, as compared to carbide tools. The benefits of the disclosed tools, materials, and production methods are improved composite, plastic, or graphite machining processes resulting from an increase in productivity and quality. FIGS. 2 and 3 are graphs of test results illustrating the differences in tool wear-related hole size changes between a standard round tool made from carbide (prior art) and a tool of substantially the same design, made from a material as described in the embodiments above. The measurements reflected in FIGS. 2 and 3 were obtained for the cutting of carbon fiber/polymer composite manufactured by Toray of Tokyo, Japan, at a surface (spindle) speed of 458 ft/min (for FIG. 2) and 65 ft/min (for FIG. 3). FIGS. 2 and 3 clearly show the more consistent hole quality obtained with drills made using the materials and manufacturing methods described herein.

The tools described herein can be used in the machining of materials, such as the plastic, graphite, or composite materials disclosed herein. In one example, this method includes providing a tool part formed from a material described herein and/or manufactured using the methods described herein, providing a material to be machined, and machining the material using the tool part. It is understood that the method may contain a greater number of steps, known to those skilled in the art, for machining.

Some composite materials which can be machined using the tools and materials described herein include, without limitation: graphite fiber reinforced polymer, glass fiber reinforced polymer, polymer with 0-90 weight % of carbon or graphite fibers, whisker reinforced polymer, and a laminate structure comprising graphite fiber reinforced polymer layers and metallic layers. The polymers referred to herein may include, without limitation, Poly(acrylics), Poly(methacrylics), Poly(alkenes), Poly(dienes), Poly(styrenes), Poly(vinyl alcohols), Poly(vinyl ketones), Poly(vinyl esters), Poly(vinyl ethers), Poly(vinyl halides), Poly(phenylenes), Poly(benzimidazoles), Poly(ethers), Poly(acetals), Poly(ureas), Poly(imines), Poly(amides), Poly(sulfides), Poly(sulfones), Poly(oxids), Poly(ether ketones), and/or copolymers of these polymers.

The disclosed materials and methods are additionally illustrated in connection with the following examples, which should only be considered as illustrative, and not limited to the specific details disclosed. The composition and firing conditions for these experiments are listed in Table I. The material properties obtained during the experiments are listed in Table II.

TABLE I

| | Silicon | Titanium | | | | | Conditions |
|---|---|---|---|---|---|---|---|
| Example | Nitride | Nitride | MWNT | Alumina | Yttria | Zirconia | Temp.[° C.] × Hours × Pressure |
| No. | [wt %] | [wt %] | [wt %] | [wt %] | [wt %] | [wt %] | [kpsi] |
| 1 | 89 | 0 | 0 | 5 | 5 | 1 | 1750 × 1 × 4.5 |
| 2 | 91 | 0 | 0 | 4.1 | 4.1 | 0.8 | 1750 × 1 × 4.5 |
| 3 | 34.3 | 61.5 | 0 | 1.9 | 1.9 | 0.4 | 1750 × 1 × 4.5 |
| 4 | 88.2 | 0 | 0.8 | 5 | 5 | 1 | 1750 × 1 × 4.5 |

TABLE II

| Example | Hardness | Toughness | Flexure Strength | Modulus |
|---|---|---|---|---|
| No. | (GPa) | MPa-mm^{0.5} | (MPa) | (GPa) |
| 1 | 14.7 | 5.4 | 1038 | 304 |
| 2 | 15.2 | 5.5 | 988 | 316 |
| 3 | 14.2 | 5.3 | 919 | 372 |
| 4 | 15.0 | 6.6 | 996 | 328 |

### EXAMPLE 1

A silicon nitride powder containing a minimum of 90 weight % α-silicon nitride with an Average Particle Size (APS) of 0.6 μm and less than 0.008 weight % of iron impurities was mixed together with alumina of an APS of 30-40 nm and a purity of >99.9 weight %, yttria with an APS of 30-50 nm and a purity of >99.9 weight %, and zirconia with an APS of 20-30 nm and a purity of 99.9 weight %. The mix ratios are listed in Table I. The powder was milled for 24 hours in hexane with zirconia media. The mixture was dried and broken up by sieving and then hot pressed at the conditions listed in Table I. The resultant ceramic material showed the properties listed in Table II.

The ceramic material thus obtained was first ground into cylinders and then machined into round tools of standard jobber drill geometry with a diameter of 0.25 inches. Carbon fiber/epoxy panels produced by Toray Industries, Inc. of Tokyo, Japan were machined with the tools produced from this material. A significant improvement in hole dimension accuracy, finish and tool life has been observed compared to standard carbide tools of the same diameter, the same flute design, at the same machining conditions.

### EXAMPLE 2

A silicon nitride powder containing a minimum of 90 weight % α-silicon nitride with an Average Particle Size (APS) of 0.6 μm and less than 0.008 weight % of iron impurities was mixed together with alumina of an APS of 30-40 nm and a purity of >99.9 weight %, yttria with an APS of 30-50 mm and a purity of >99.9 weight %, and zirconia with an APS 20-30 nm and a purity of 99.9 weight %. The mix ratios are listed in Table I. The powder was milled for 24 hours in hexane with zirconia media. The mixture was dried and broken up by sieving and then hot pressed at the conditions listed in Table I. The resultant ceramic material showed the properties listed in Table II. The material was machined into inserts and round tools and tested as described in Example 1. Again a superior performance to tools and inserts of the same geometry and dimensions compared to carbide tools has been observed.

### EXAMPLE 3

A silicon nitride powder containing a minimum of 90 weight % α-silicon nitride with an Average Particle Size (APS) of 0.6 μm and less than 0.008 weight % of iron impurities was mixed together with alumina of an APS of 30-40 nm and a purity of >99.9 weight %, titanium nitride with an APS of 1.0 μm, yttria with an APS of 30-50 nm and a purity of >99.9 weight %, and zirconia with an APS 20-30 nm and a purity of 99.9 weight %. The mix ratios are listed in Table I. The powder was milled for 24 hours in isopropyl alcohol with zirconia media. The mixture was dried and broken up by sieving and then hot pressed at the conditions listed in Table I. The resultant ceramic material showed the properties listed in Table II. It was again machined into round tools and tested as described in Example 1. A performance improvement of the thus obtained tools of the same geometry and dimensions compared to carbide tools has been observed.

### EXAMPLE 4

A silicon nitride powder containing a minimum of 90 weight % α-silicon nitride with an Average Particle Size (APS) of 0.6 μm and less than 0.008 weight % of iron impurities was mixed together with multi-walled carbon nanotubes of inner diameter 2-15 nm and a length of 1-10 μm, alumina of an APS of 30-40 nm and a purity of >99.9 weight %, yttria with an APS of 30-50 nm and a purity of >99.9 weight %, and zirconia with an APS 20-nm and a purity of 99.9 weight %. The mix ratios are listed in Table I. The powder was milled for 24 hours in hexane with zirconia media. The mixture was dried and broken up by sieving and then hot pressed at the conditions listed in Table I. The resultant ceramic material showed the properties listed in Table II. The material was machined into inserts and round tools and tested as described in Example 1. Again a superior performance to tools and inserts of the same geometry and dimensions compared to carbide tools has been observed.

As described above, the disclosed materials and methods of production, as well as tools made therefrom, exhibit markedly increased tool life and hole quality in machined composites, compared to prior carbide tools. This results in increased productivity and quality, creating improved composite, plastic, or graphite machining processes.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the compositions listed herein and the ranges thereof are approximations, and may be varied slightly without departing from the scope of the invention. It is also understood that the ranges expressed herein include the end points of the range. For example, a range beginning at 0 weight % may be completely devoid of the substance in question. It is further understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying claims.

What is claimed is:

1. A ceramic material comprising:
at least about 10 weight % silicon nitride; and
between about 2 and 20 weight % of an intergranular phase comprising at least two oxides of elements selected from the group consisting of: magnesium, aluminum, and rare earth metals.

2. The ceramic material of claim 1, further comprising up to about 3 weight % multi-walled carbon nanotubes.

3. The ceramic material of claim 1, further comprising up to about 70 weight % titanium nitride.

4. The ceramic material of claim 1, further comprising up to about 80 weight % titanium nitride.

5. The ceramic material of claim 1, wherein the intergranular phase comprises at least one oxide selected from the group consisting of: magnesium and aluminum, and at least one oxide selected from the group consisting of rare earth metals.

6. The ceramic material of claim 1, wherein the intergranular phase comprises at least one oxide selected from the group consisting of: yttrium, cerium, and zirconium.

7. The ceramic material of claim 1, wherein the material comprises about 7-13 weight % of the intergranular phase.

8. The ceramic material of claim 1, wherein the intergranular phase comprises between about 2 and 8 weight % of aluminum or magnesium oxide, between about 2 and 8 weight % of yttrium or cerium oxide, and between about 0 and 5 weight % of zirconium oxide.

9. The ceramic material of claim 1, wherein the material has a microstructure containing predominately acicular β-grains of silicon nitride.

10. The ceramic material of claim 1, wherein the material contains substantially no titanium nitride.

11. The ceramic material of claim 1, wherein the material comprises between about 80 and 95 weight % silicon nitride.

12. A ceramic cutting tool part comprising the ceramic material of claim 1.

13. A method for manufacturing a tool part comprising:
(i) providing a powder mixture comprising:
(a) at least about 10 weight % silicon nitride; and
(b) between about 4 and 20 weight % of an oxide mixture comprising at least two oxides of elements selected from the group consisting of: magnesium, aluminum, and rare earth metals;
(ii) forming the powder into a pre-form;
(iii) consolidating the pre-form into a blank by heating to a temperature in the range of from about 1650° C. to 1850° C.; and
(iv) machining the blank to form the tool part.

14. The method of claim 13, wherein the powder mixture further comprises up to about 3 weight % multi-walled carbon nanotubes.

15. The method of claim 13, wherein the powder mixture further comprises up to about 70 weight % titanium nitride.

16. The method of claim 13, wherein the powder mixture further comprises up to about 80 weight % titanium nitride.

17. The method of claim 13, wherein the oxide mixture comprises at least one oxide selected from the group consisting of: magnesium and aluminum, and at least one oxide selected from the group consisting of rare earth metals.

18. The method of claim 13, wherein the oxide mixture comprises at least one oxide selected from the group consisting of: yttrium, cerium, and zirconium.

19. The method of claim 13, wherein the powder mixture comprises about 7-13 weight % of the oxide mixture.

20. The method of claim 13, wherein the oxide mixture comprises between about 2 and 8 weight % of aluminum or magnesium oxide, between about 2 and 8 weight % of yttrium or cerium oxide, and between about 0 and 5 weight % of zirconium oxide.

21. The method of claim 13, wherein the oxide mixture comprises aluminum oxide, yttrium oxide, and zirconium oxide with average particle sizes of less than 50 nm.

22. The method of claim 13, wherein the powder mixture comprises between about 80 and 95 weight % silicon nitride.

23. A method for machining a piece comprising:
(i) providing the piece;
(ii) providing a ceramic cutting tool made from a material containing silicon nitride; and
(iii) machining the piece using the cutting tool.

24. The method of claim 23, wherein the cutting tool is a monolithic ceramic body.

25. The method of claim 23, wherein the cutting tool comprises at least one cutting insert made from a material containing silicon nitride.

26. The method of claim 23, wherein the piece is made from a composite material comprising a graphite fiber reinforced polymer.

27. The method of claim 23, wherein the piece is made from a composite material comprising a glass fiber reinforced polymer.

28. The method of claim 23, wherein the piece is made from a composite material comprising a polymer with up to 90 weight % of carbon or graphite fibers.

29. The method of claim 23, wherein the piece is made from a composite material comprising a whisker reinforced polymer.

30. The method of claim 23, wherein the piece is made from a composite material having a laminate structure comprising graphite fiber reinforced polymer layers and metallic layers.

31. The method of claim 23, wherein the piece is made from a material comprising a polymer selected from the group consisting of: Poly(acrylics), Poly(methacrylics), Poly(alkenes), Poly(dienes), Poly(styrenes), Poly(vinyl alcohols), Poly(vinyl ketones), Poly(vinyl esters), Poly(vinyl ethers), Poly(vinyl halides), Poly(phenylenes), Poly(benzimidazoles), Poly(ethers), Poly(acetals), Poly(ureas), Poly(imines), Poly(amides), Poly(sulfides), Poly(sulfones), Poly(oxids), Poly(ether ketones), and copolymers of these polymers.

32. The method of claim 23, wherein the material of the ceramic cutting tool has a porosity of less than about 2 volume %.

33. The method of claim 23, wherein the material of the ceramic cutting tool comprises:
at least about 10 weight % silicon nitride; and
between about 4 and 20 weight % of an intergranular phase comprising at least two oxides of elements selected from the group consisting of: magnesium, aluminum, and rare earth metals.

34. The method of claim 33, wherein the material of the ceramic cutting tool further comprises up to about 80 weight % titanium nitride.

35. The method of claim 33, wherein the material of the ceramic cutting tool further comprises up to about 3 weight % multi-walled carbon nanotubes.

36. A ceramic material comprising:
at least about 10 weight % silicon nitride; and
up to about 3 weight % multi-walled carbon nanotubes.

37. A ceramic material comprising:
at least about 10 weight % silicon nitride; and
up to about 70 weight % titanium nitride.
